(19) United States
(12) Patent Application Publication
(10) Pub. No.: US 2025/0299261 A1
(43) Pub. Date: Sep. 25, 2025

(54) Systems and Methods for Insurance Fraud Prevention using Artificial Intelligence

(71) Applicant: Efthemios E. Christopoulos, Woburn, MA (US)

(72) Inventor: Efthemios E. Christopoulos, Woburn, MA (US)

(21) Appl. No.: 18/609,628

(22) Filed: Mar. 19, 2024

(51) Int. Cl. G06Q 40/08; G06Q 30/018; G06T 7/00

(52) U.S. Cl. CPC G06Q 40/08; G06Q 30/0185; G06T 7/0002; G06T 2207/20081

(57) ABSTRACT

The disclosed invention pertains to a computer system enhanced by artificial intelligence designed to accurately assess vehicle damage and estimate repair costs. It includes a graphical user interface for capturing and uploading vehicle images, a server for analyzing these images to detect various damage levels, and a database for storing vehicle and report information. Key features include a self-diagnostic algorithm to ensure unbiased AI operation and a hybrid user interface that integrates damage reports with direct links to third-party repair services. The system employs a sophisticated AI capable of differentiating between minor, moderate, and major vehicle damage. This technology enables a streamlined, accurate, and user-friendly method for a variety of scenarios, including, but not limited to insurance value approximation, body shop estimating, used car appraisals, and the like.

### BACKGROUND OF THE INVENTION

The present disclosure relates generally to systems and methods for insurance fraud prevention using artificial intelligence (“AI”). More particularly, the present disclosure relates to a computer system providing for picture analysis with AI to determine the extent of damage and the estimated cost to repair said damage on a vehicle.

In the current landscape of insurance policy initiation, particularly within the automotive sector, there exists a significant challenge related to accurately appraising new policies in light of pre-existing damage to vehicles. One of the issues is the absence of a mechanism to stop individuals from insuring vehicles that already have damage, only to subsequently file claims for these pre-existing conditions. This loophole not only engenders substantial financial losses for insurance companies but also undermines the integrity of the insurance system, inflating premiums for honest policyholders.

Moreover, while computerized systems offer promising avenues for enhancing the accuracy and efficiency of damage assessment and insurance approximation, they are not without their challenges. Traditional computer systems struggle to dynamically analyze and interpret complex visual data, a task that is essential for identifying fraudulent claims related to pre-existing vehicle damage. Conventional computer systems typically rely on static rule-based algorithms and manual data entry, which are very time-intensive. This leads to a reactive approach, where fraud may be detected only after a claim has been paid out, rather than proactively at the policy's inception. These systems also lack the advanced pattern recognition capabilities required to analyze the nuances of vehicle damage through images, resulting in a higher rate of undetected fraud.

Previous attempts to mitigate insurance fraud, particularly concerning pre-existing vehicle damage, have largely centered on manual inspections and periodic database checks. These methods, however, have proven to be both time-consuming and prone to human error. Similarly, traditional computer systems lack the sophistication to effectively analyze and learn from diverse datasets of vehicle images, which is crucial for accurate damage assessment. Consequently, these known methods have only perpetuated the automotive insurance industry's vulnerability to fraudulent activity.

There are a countless number of other solutions to the aforementioned problems; however, the results of implementing any one solution are unpredictable due to the inherent complexities involved. Therefore, what is needed is a computer system and method of insurance fraud prevention using AI.

### SUMMARY OF THE INVENTION

The subject matter of this application may involve, in some cases, interrelated products, alternative solutions to a particular problem, and/or a plurality of different uses of a single system or article.

In one aspect, a computer system is disclosed that includes a computing device equipped with a processor and memory. This memory stores instructions that the processor executes. In this aspect, a user interface is provided to facilitate user access to the computer system. A user input device, which is in electronic communication with the computing device, allows users to input data and commands effectively. Moreover, a monitor, also in electronic communication with the computing device, is specifically configured to display this user interface, ensuring that users can easily navigate and utilize the system's features. Furthermore, an electronic communication line connects the computing device to a server, which contains a database. This computer system is capable of analyzing pictures of vehicles using artificial intelligence to determine the extent of any damage and estimate the cost required for repairs.

In another aspect, a method is disclosed that involves the use of a mobile device to capture a picture of a vehicle. Following the capture, this picture is then uploaded to a computer system directly from the mobile device. In this aspect, the computer system is equipped with artificial intelligence. Once the picture has been uploaded, the artificial intelligence within the computer system proceeds to analyze the picture.

These aspects of the invention are not meant to be exclusive and other features, aspects, and advantages of the present invention will be readily apparent to those of ordinary skill in the art when read in conjunction with the following description, appended claims, and accompanying drawings.

### BRIEF DESCRIPTION OF DRAWINGS

FIG. 1 provides a diagrammatic representation of one embodiment of the computer system.

FIG. 2 provides a diagrammatic representation of another embodiment of the computer system.

FIG. 3 provides a perspective view of one embodiment of a training image of a car without any damage.

FIG. 4 provides a perspective view of another embodiment of a training image of a car with damage of varying severities.

FIG. 5 provides a flowchart representation of one embodiment of the method performed by the computer system.

FIG. 6 provides a perspective view of one embodiment of a user interface for a car damage report generated and displayed by the computer system.

FIG. 7 provides a perspective view of an embodiment of a hybrid user interface generated and displayed by the computer system.

### DETAILED DESCRIPTION OF THE INVENTION

The detailed description set forth below in connection with the appended drawings is intended as a description of presently preferred embodiments of the invention and does not represent the only forms in which the present disclosure may be constructed and/or utilized. The description sets forth the functions and/or the sequence of steps for constructing and operating the invention in connection with the illustrated embodiments.

Generally, the present disclosure concerns a computer system and method for preventing insurance fraud using AI. Specifically, the computer system is operable to analyze pictures with AI to determine the extent of damage and the estimated cost to repair said damage on a car. The computer system and method disclosed herein may be advantageously used in the automotive industry to assist with body shop estimating, used car appraisals, and, preferably, insurance approximation of the value of an initial damage report for a vehicle. In the insurance approximation scenario, the system would be operable to notify the underwriters of any pre-existing damage and associated repair costs before initiation of a new policy.

In most embodiments, the system may include a non-transitory computer readable medium or memory, which contains instructions allowing and instructing at least one central processing unit (“CPU” or “processor”) to carry out the steps required during operation, as described herein. This non-transitory computer readable medium or memory may be housed within a computing device, or may be accessible through an electronic communication system, such as a network. When used herein the term “computing device” means any electronic device having a processor, memory, and a graphical user interface (“GUI”) display, including, but not limited to, a cellular phone, a tablet, a laptop, or a desktop. Also, when used herein the term “network” refers to any system of interconnected electronic devices, such as, a cellular communication network or the Internet. Connections in the network may be wired or wireless.

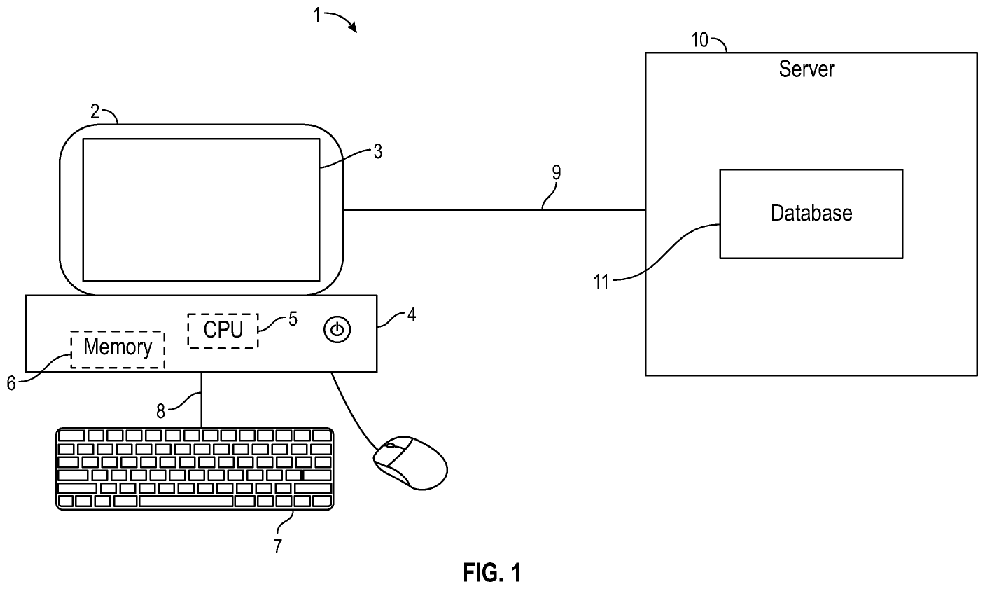

Turning now to FIG. 1, a diagrammatic representation of one embodiment of the computer system 1 is shown. In this embodiment, the computer system comprises several key components, including, but not limited to a monitor 2 and a graphical user interface 3. The monitor 2 facilitates user access to the system 1 by providing a graphical user interface 3 through which users interact with the system 1. As used herein, the term “monitor” encompasses any electronic display or visual output device capable of presenting graphical or textual information to a user. Such monitors may include, but are not limited to, desktop computer monitors, laptop screens, tablet displays, mobile phone screens, and any other portable or fixed electronic screens or displays designed for human interaction and information presentation.

The computer system 1 also includes a computing device 4, which serves as the core processing unit. The computing device 4 comprises essential components, including, but not limited to, a central processing unit or processor 5 and a memory 6. The central processing unit 5 is responsible for executing various instructions and performing computational tasks. The memory 6 stores instructions and data that are essential for the system operation. These stored instructions are executed by the processor 5 in order to carry out the computer-based method of insurance fraud prevention.

Similar to the term “monitor,” as used herein, the term “computing device” encompasses any electronic device or apparatus with the capability to process data, execute instructions, and perform computational tasks. Such computing devices may include, but are not limited to, desktop computers, laptops, tablet computers, mobile phones, servers, embedded systems, wearable devices, and any other electronic systems or hardware configured for information processing, storage, and communication.

To facilitate user interaction with the computer system 1, user input devices 7 are provided. In the embodiment shown in FIG. 1, these devices 7 include a mouse and a keyboard, but the term “input device” is meant to encompass any hardware or components designed to facilitate user interaction and input with a computing device, including, but not limited to, touchscreens. The input devices 7 are connected to the computing device 4 through electronic communication lines 8. These communication lines can be either short-range wireless connections, such as a Bluetooth® connection, or hard-wired connections.

As previously described, the computer system 1 includes a computing device 4 and a monitor 2. In this context, the computing device 4 is configured to cause the monitor 2 to display a website or application that embodies the system for preventing insurance fraud on the user interface 3. This user interface 3 provides users with a platform to interact with and utilize the system, such as by uploading photos of a vehicle for analysis or receiving a notification regarding pre-existing damage on the vehicle.

The system 1 also includes an electronic communication line 9. This line 9 may encompass both wired and wireless connections, including connections to computerized device networks, such as the Internet, cellular networks, and the like. The electronic communication line 9 connects the computing device 4 to a server 10 specifically designed to support the analysis of photos using AI and the preparation of damage and repair cost reports for insurance policy underwriters. This server 10 contains a database 11 that stores the necessary files and information required for the operation of the system for preventing insurance fraud. Such files and information may include historical data, statistical models, user preferences, and any other relevant information. This information may also be stored, entirely or in part, on the memory 6 of the computing device 4.

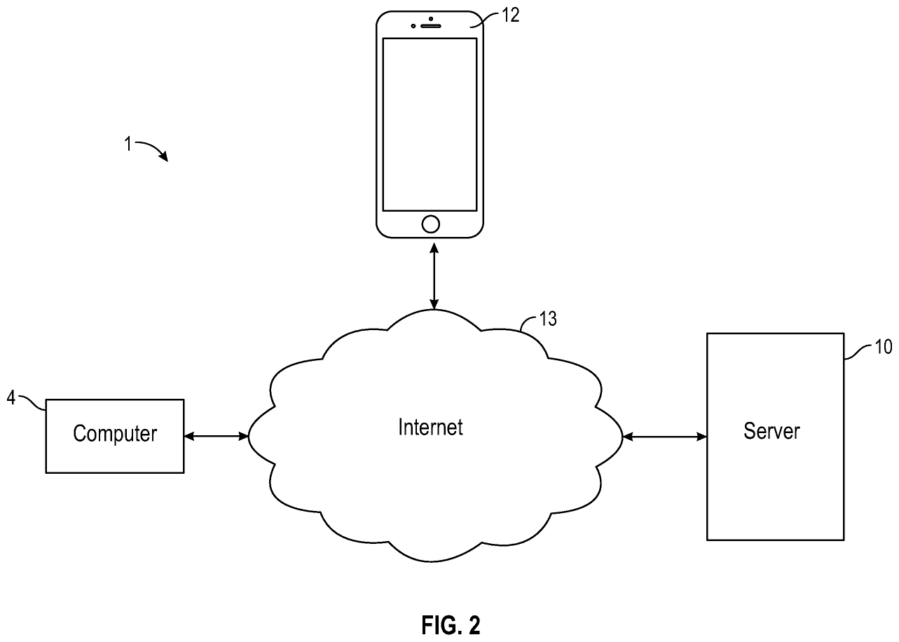

In FIG. 2, a diagrammatic representation illustrates another embodiment of the computer system 1 with a slightly expanded architecture. In this embodiment, the first computing device 4 and the server 10 are interconnected through the Internet 13, establishing a networked connection that facilitates communication and data exchange. The second computing device 12, depicted as a mobile device, is equipped with a camera and is also linked to the Internet 13, enabling it to capture and transmit images remotely.

In practical application, the second computing device 12 could be employed by an individual to capture images of their vehicle in order to initiate a new insurance policy or file a claim with an existing one. These images can then be directly uploaded to the system 1 through the Internet 13. During the upload process, all data associated with the images would be transferred to and stored on either the first computing device 4 or the server 10, where they would then be subject to further analysis.

For example, upon receiving the images, the server 10 or the first computing device 4 would initiate a process for assessing any visible damage. Utilizing AI algorithms, the system 1 may examine the uploaded pictures to identify areas of damage and evaluate their severity. Based on this analysis, a comprehensive damage and repair cost report may be generated. In this example, the first computing device 4 may be operated by an insurance policy underwriter. This professional could then use the generated reports to make informed decisions regarding policy initiation or claim resolution.

The aforementioned process for generating comprehensive vehicle damage and repair cost reports for use by policy underwriters illustrates a technical problem solved by the present disclosure. Particularly, the generation of such reports relies on image analysis, which is a complex process with several technical challenges, all of which stem from the difficulty of having a binary machine accurately perform human-like tasks. The variability in damage types, the quality of images, and differing lighting conditions, are all factors that may impact a standard computer's performance. However, the present disclosure solves this problem by integrating a machine learning algorithm into the computer's operational protocol.

A machine learning algorithm is a class of AI that may enable a computer system to effectively analyze a picture of a vehicle for damage without being explicitly programmed to do so. This process of machine learning begins by training the computer with extensive datasets that accurately represent a wide range of damage scenarios. In most embodiments, the image data may be stored in a database on a server, and a processor may ultimately execute the steps required for training the computer.

The machine learning model generally works through a two-step process: pre-training and fine-tuning. In the pre-training phase, the computer may be exposed to a vast number of images, ranging from vehicles in pristine condition to vehicles that are beyond repair. This may allow the model to learn patterns in the data and make better decisions in the future. Upon conclusion of the pre-training phase, the machine learning algorithm may be indistinguishable from AI that is capable of learning from experience, adjusting to new inputs, and performing human-like tasks.

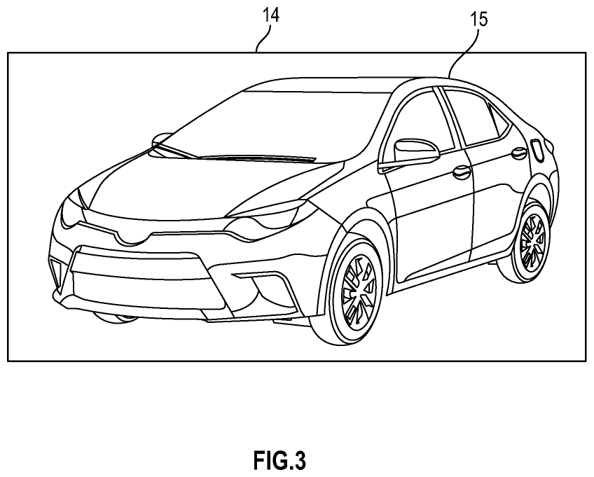

FIG. 3 presents a perspective view of a training image 14, specifically an undamaged car 15. The picture is but one of many within a comprehensive dataset designed to train an AI system in automotive image analysis. The car 15 shown is free of any visible defects, serving as a baseline against which the AI can compare other images to detect anomalies indicative of damage. It is essential for the AI to be familiar with the pristine condition of various makes and models of cars to distinguish between factory lines and actual damage when it analyzes vehicles. The importance of training images 14 showing undamaged vehicles cannot be overstated, as they are foundational to the AI's ability to discern the subtleties in automobile conditions.

Training the AI with images of undamaged cars also aids in reducing false positives, where the AI might incorrectly identify a feature of the car as damage. For instance, the clear contours, unblemished surfaces, and the intact integrity of the windows, bodywork, and wheels in the training image 14 provide a reference for the AI. By assimilating a multitude of such images, the AI develops a ‘memory’ of undamaged states, which it then utilizes as a benchmark for analysis. Through this learning process, the AI system refines its algorithms to ensure high precision in damage detection, which is paramount for the accurate appraisal of vehicle conditions in scenarios such as insurance value approximation, body shop estimating, used car appraisals, and the like.

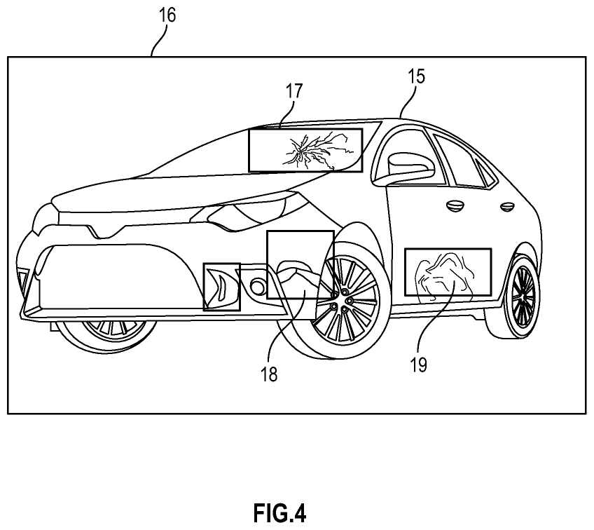

FIG. 4 provides a perspective view of another training image 16 that features a car 15 with various degrees of inflicted damage, which is also vital for training the AI in damage assessment. The training image 16 showcases the car 15 with clearly delineated areas of damage, categorized by severity to aid the AI in recognizing and distinguishing between different damage levels.

Major damage 17 is represented with significant visual impact, such as the extensive cracking on the window, which implies a forceful impact. This type of damage often requires comprehensive repair work, including potential replacement of parts, and is crucial for the AI to identify correctly as it typically impacts vehicle safety and value dramatically.

Minor damage 18 is exemplified by smaller dents and scratches on the bodywork of the car, which are common and might not affect the vehicle's operation but can still influence the car's aesthetic and resale value. Training the AI to spot these subtleties ensures that even the smallest imperfections are accounted for in the overall damage assessment.

Moderate damage 19 is depicted as more significant than minor damage but less than major damage, like the deformations on the door. It stands in a category that might not compromise the integrity of the vehicle's critical functions but could require more than just cosmetic repairs.

The combination of these damage types in a single training image 16 is instrumental for the AI to learn the breadth of vehicle damage. The visual complexity within this image helps in refining the AI's analytical capabilities to produce accurate, tiered damage assessments. It becomes a learning tool, teaching the AI the varying degrees of repair urgency and cost, which is pivotal for providing reliable estimates in insurance claim processing and underwriting.

As previously described, a vast number of images like those shown in FIG. 3 and FIG. 4 are necessary to train the AI during the first, pre-training phase. In the second, fine-tuning phase, the AI's performance may be tailored to the specific task of using the analyzed image data to prepare a comprehensive vehicle damage and repair estimate reports. This may involve introducing the AI to a nuanced dataset that includes detailed damage reports paired with corresponding repair invoices and outcomes. By employing techniques such as supervised learning and regression analysis, the AI may learn to interpret the contextual details of the damage (e.g., location, depth, and impact on vehicle functionality) and align these with accurate cost ranges. Iterative training, combined with feedback loops may allow the AI to refine its estimates, ensuring they are comprehensive and align with real-world repair standards and pricing.

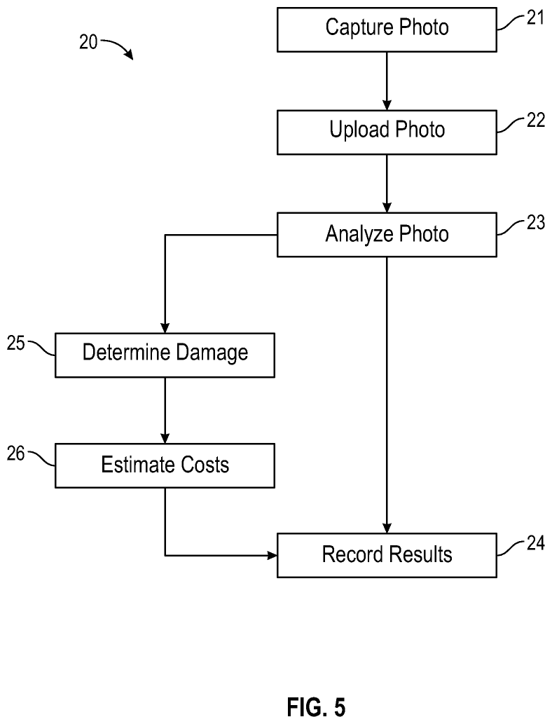

The properly trained AI may be integrated into a computer-based system operable to perform the steps of a method for damage assessment and repair cost estimation. FIG. 5 provides a flowchart representing the steps of such an operational method 20. In this embodiment, the method commences with the step of capturing a photograph 21 of a vehicle, which may be performed by a camera of a smartphone or tablet of an individual seeking to initiate an insurance policy. An insurance company may require the individual to take one or more pictures of the vehicle from different angles to ensure that any damage is documented for subsequent analysis.

Once the photo is captured, the individual may initiate the next step of uploading the photo 22 through the computer system. Here, the image is transferred from the capturing device to an underwriter's computing device, the system server, or both for storage and preliminary processing and analysis. This step may involve interaction with cloud services and the Internet.

At this juncture, the system is operable to perform the step of analyzing the photo 23. In this step, either a computing device or the server of the computer system apply AI and machine learning algorithms to scrutinize the uploaded photo for signs of damage. This analysis may be performed by utilizing the training images discussed previously.

If no damage is detected, the analysis is complete, and the computer system immediately records the results 24, documenting the findings of the photo analysis in a report. This documentation step is critical, as it ensures that the initial findings are preserved for further review and action.

However, if during the step of analyzing a photo 23 the system identifies any indications of damage, the AI immediately advances to determining the extent of the damage 25. In this stage, the AI may pinpoint the location, type, and severity of the damage present on the vehicle. This information is extracted from the visual data with the help of the AI's trained algorithms.

Subsequently or simultaneously, the AI may engage in estimating the costs to repair the damage 26. This step involves calculating the financial outlay that may be required to address the identified damage by either a computing device, the server, or both in networked communication. The AI may utilize the determined damage specifics to generate an accurate cost estimate for repairs.

Again, the method concludes with recording the results of the AI's analysis 24. The data regarding the damage and estimated repair costs may be systematically documented. This record can then be reviewed by insurance underwriters, car owners, or repair professionals to make informed decisions. In the case of insurance underwriters, the documentation or damage report prepared by the AI can be used as a basis to deny subsequent claims for the repair of pre-existing damage.

Now, while the use of AI and machine learning algorithms to analyze images solves the technical computer problem of having a binary machine interpret data without being explicitly programmed to do so, it may also create another technical challenge. Specifically, an AI image analyzer functions by learning from training datasets, but if these datasets are not representative of all scenarios or are skewed in some way, the AI may inherit these biases. For example, if an AI trained to analyze vehicle damage is mostly fed images of cars from a specific manufacturer, geographic region, or color, it might not perform as accurately with different makes, regions, or colored vehicles. This is due to a lack of diverse examples from which to learn.

Furthermore, if the training data contains a disproportionate number of certain types of damage or overlooks others, the AI might develop a bias towards frequently seen damage, leading to a higher false positive rate for less represented damage types. Biases like these can also manifest if the data includes subconscious human biases, such as areas more frequently inspected by humans or assumptions about which parts are more prone to damage. These inherited biases can result in skewed predictions or results. For instance, an AI might overestimate the severity of damage on models it's overly familiar with, while underestimating or even missing damage on less represented models. Consequently, this may impact the accuracy of repair cost estimations and insurance claim processes.

In order to solve the technical issues of inherited biases and skewed results stemming from the use of an AI image analyzer, the computer system may utilize a self-diagnostic algorithm configured to regularly evaluate and adjust the significance given to various factors specific to the task at hand. This algorithm may be operable to detect and correct any biases within the vehicle damage assessment model. By consistently reviewing the image analyzer's output, the algorithm could pinpoint patterns that may indicate bias or errors in the damage evaluation process. If such patterns are detected, the system may have the capability to refine its assessment algorithm autonomously. This refinement may entail recalibrating the machine learning algorithm's parameters or enriching the training data to ensure a more balanced representation of damage types across different vehicles. This iterative process of self-diagnosis and recalibration may enhance the precision of the system's damage assessments and cost estimations, thereby reducing the likelihood of bias against certain vehicle categories or damage conditions.

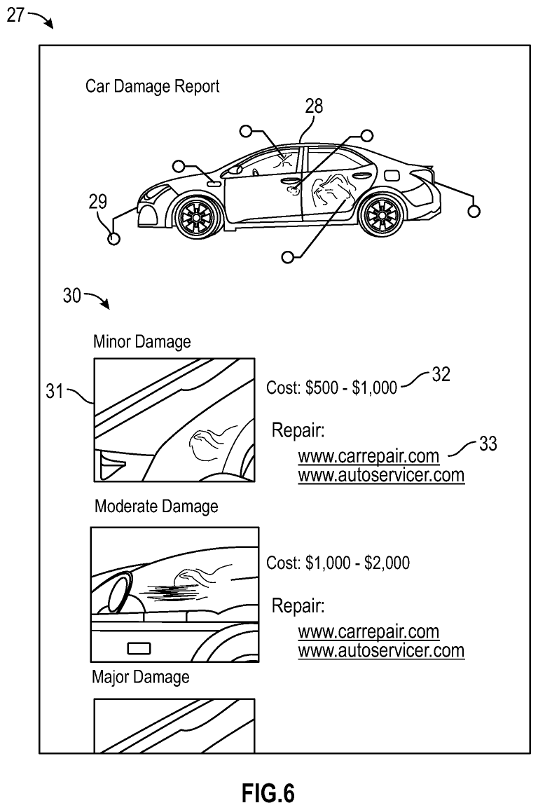

Turning now to FIG. 6, which provides a perspective view of a user interface 27 showcasing a car damage report prepared by the AI utilized by the computer system. The interface 27 displays a car 28 with multiple damage indicators 29 that mark the locations of identified damage on the vehicle's illustration. These indicators may correspond to areas analyzed by the AI, where it has detected anomalies against its trained model of damaged and undamaged vehicles.

Below the image of the car 28 on the user interface 27 are categorized sections of the damage report 30, where different types of damage are listed as ‘Minor Damage’, ‘Moderate Damage’, and ‘Major Damage’. Each category is accompanied by a visual representation or icon 31 for quick recognition. The icons 31 may be linked to the damage indicators 29, so that when an icon 31 or damage indicator 29 is clicked, the user interface 27 will navigate from icon 31 to damage indicator 29, and vice versa, emphasizing the associated damage.

The cost of repairs 32 is specified next to each damage type, providing a range that offers an estimate of potential repair expenses. Hyperlinks to repair websites 33 are also provided under each category of damage. The repair estimates 32 and hyperlinks 33 may be incorporated into the damage report by the AI from publicly available data sources. This capacity to access and integrate external data may ensure that the repair estimates reflect current rates and labor charges.

In the context of insurance value approximation, this integrated information may allow an insurance underwriter to double-check the AI's performance by verifying repair estimates 32 through an external source. Similarly, in the context of body shop estimates, the hyperlinks 33 to third-party services may streamline the repair process for a user, allowing them to simply click on a link and immediately be directed to an appropriate service provider that may be capable of rectifying the corresponding damage.

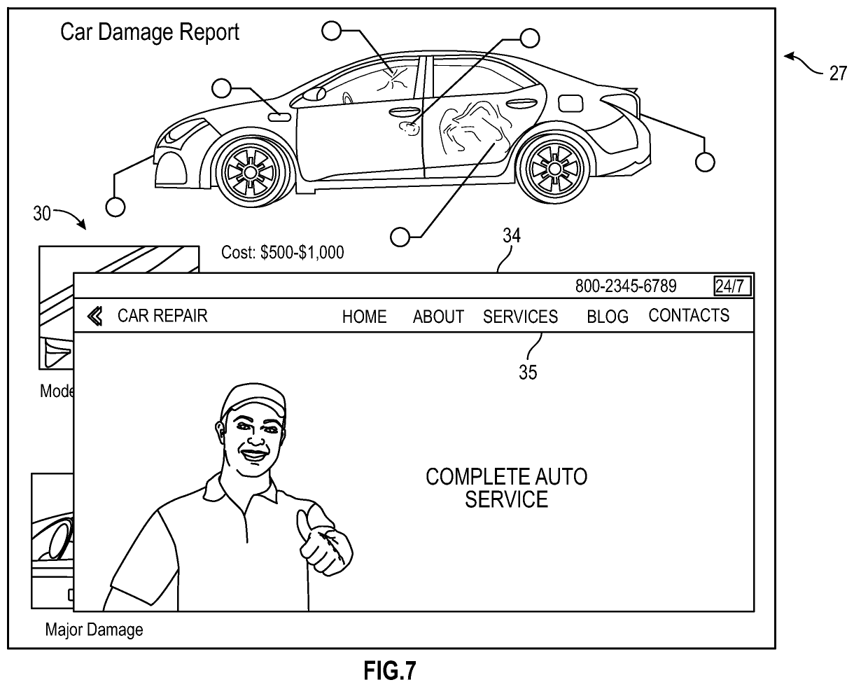

In one embodiment, when a hyperlink 33 is clicked, the system is operable to create a hybrid user interface on the same user interface 27 as the damage report 30. FIG. 7 provides an example of such a hybrid interface. This interface 27 displays an integrated user interface 34 overlayed on the damage report 30 within the same viewing pane, thereby eliminating the need for separate windows or tabs and streamlining the user experience.

A third-party repair website 35 is displayed within the integrated user interface 34. Instead of navigating away from the damage report 30, the selected repair website 35 is displayed within the bounds of the existing interface 27, providing a unified view that includes navigation options like ‘HOME’, ‘ABOUT’, ‘SERVICES’, ‘BLOG’, and ‘CONTACTS’, as well as direct contact information for the repair service. This integration supports the user in making informed decisions by presenting all necessary information and actions in one place.

While all of the embodiments described herein represent a technical improvement, the embodiment shown in FIG. 7 in particular illustrates a technical problem solved related to graphical user interfaces. For example, it is common in the field of computers for the selection of a hyperlink 33 to cause the computing device to navigate to a separate user interface. This separate user interface may be displayed from a different website address on a server or in a separate window on a computer or mobile application. The reason for a third-party website 35 being displayed on a separate user interface may be a limited availability of display space on computer monitors or mobile device screens, which is a technical problem specific to computerized devices that can disrupt user workflow and potentially lead to a loss of context.

However, the present disclosure solves this problem by creating a hybrid user interface that simultaneously displays an integrated user interface 34 for a third-party website 35 on the same user interface 27 as an AI-generated car damage report 30. This hybrid interface not only solves a technical problem in the field of computers, but it also helps users identify and target specific areas for repair without needing to navigate away from a primary user interface 27 and potentially losing track of progress. In other words, this feature ensures that critical information is readily accessible and promotes efficient decision-making in all scenarios where the presently disclosed systems and methods might be advantageously employed.

While several variations of the present disclosure have been illustrated by way of example in preferred or particular embodiments, it is apparent that further embodiments could be developed within the spirit and scope of the present disclosure, or the inventive concept thereof. However, it is to be expressly understood that such modifications and adaptations are within the spirit and scope of the present disclosure, and are inclusive, but not limited to the following appended claims as set forth below.

What is claimed is:

1. A computer system comprising:
a computing device housing a processor and a memory, the memory storing instructions for execution by the processor;
a user interface facilitating access to the computer system;
a user input device in electronic communication with the computing device;
a monitor in electronic communication with the computing device, the monitor configured to display the user interface; and
an electronic communication line connecting the computing device to a server containing a database;
wherein the computer system is operable to analyze a picture of a vehicle using artificial intelligence to determine an extent of damage and an estimated cost to repair the vehicle.

2. The computer system of claim 1 wherein at least one of the computing device or the server are operable to analyze the picture of the vehicle using artificial intelligence.

3. The computer system of claim 1 wherein the user input device comprises at least one of a mouse, a keyboard, or a touch screen.

4. The computer system of claim 1 wherein the computer system is operable to generate a report summarizing the extent of damage and the estimated cost to repair the vehicle.

5. The computer system of claim 1 wherein the artificial intelligence is trained using a dataset of vehicle images depicting a plurality of different types of vehicle damage.

6. The computer system of claim 5 wherein the plurality of different types of vehicle damage comprises a plurality of undamaged vehicles, a plurality of minorly damaged vehicles, a plurality of moderately damage vehicles, and a plurality of severely damage vehicles.

7. The computer system of claim 1 wherein the database within the server contains historical repair data corresponding to a plurality of different types of vehicle damage.

8. The computer system of claim 7 wherein the artificial intelligence uses the historical repair data corresponding to the plurality of different types of vehicle damage to determine the estimated cost to repair the vehicle.

9. The computer system of claim 1 further comprising a second computing device comprising a camera, the second computing device in networked communication with the computing device.

10. The computer system of claim 9 wherein the second computing device is operable to capture the picture with the camera and upload the picture to at least one of the computing device or the server via the electronic communication line.

11. The computer system of claim 1 wherein the database within the server is operable to store and retrieve repair cost data from a third-party repair website to support the estimated cost to repair the vehicle.

12. The computer system of claim 1 wherein the user interface displays a report summarizing the extent of damage and the estimated cost to repair the vehicle.

13. The computer system of claim 12 wherein the report comprises the picture of the vehicles having a plurality of damage indicators pointing to areas of detected damage.

14. The computer system of claim 12 wherein the report comprises a hyperlink to a third-party repair website.

15. The computer system of claim 14 wherein the computing device is operable to integrate the third-party repair website within the user interface.

16. The computer system of claim 15 wherein the integration of the third-party repair website within the user interface creates a hybrid user interface.

17. A computer-based method comprising:
utilizing a mobile device to capture a picture of a vehicle;
uploading the picture to a computer system from the mobile device;
wherein the computer system utilizes artificial intelligence; and
analyzing the picture by the artificial intelligence.

18. The method of claim 17 further comprising recording results from the picture analysis in a database.

19. The method of claim 17 further comprising determining an extent of damage to the vehicle based on the picture analysis.

20. The method of claim 17 further comprising estimating a cost to repair the vehicle based on the picture analysis.
